(19) United States
(12) Patent Application Publication
(10) Pub. No.: US 2003/0142328 A1
(43) Pub. Date: Jul. 31, 2003

(54) Evaluation of image processing operations

(76) Inventors: Stanley Eugene McDaniel, San Diego, CA (US); Alan Eddy Cariffe, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/062,990

(22) Filed: Jan. 31, 2002

(51) Int. Cl. G06F 15/00; B41J 1/00

(52) U.S. Cl. 358/1.9

(57) ABSTRACT

Various systems, methods, and programs embodied on a computer readable medium are provided for image processing evaluation. In one embodiment, a method is provided that comprises the steps of forecasting a number of image processing parameters of an image processing operation based upon at least one image processing setting, displaying the image processing parameters on a display device, and, performing a preoperative task based upon a user input in response to the display of the image processing parameters.

### BACKGROUND OF THE INVENTION

Optical scanning devices such as flat bed scanners, sheet fed scanners, and multifunction peripherals sometimes present a user control interface via a software program running on an attached or embedded processor system. Such control interfaces often provide a user with the opportunity to select or customize the image processing settings associated with a scan function, copy function, or other functions.

However, in various scanning and/or copying functions, it may be the case that a user may choose image processing settings that require hardware or other resources beyond the capabilities of the attached computer system. Assume, for example, an extreme case where a user wishes to scan a single 8×10 inch color picture at an optical resolution of 9600 dpi and a 24 bit color depth representing 3 bytes per pixel. The resulting image will have 7,372,800,000 pixels. Since each pixel is represented by three bytes of color information, then a total of 22,118,400,000 bytes of memory may be needed to store the resulting image. This is more than 22 Gigabytes of memory or data storage that may not be available in the computer system. As a result, the desired scan or copy function would likely fail. In the case that sufficient memory is available, then even a fast computer may still take hours to absorb and process the image using such image processing settings.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a computer system that employs an image processing evaluator;

FIG. 2 is a user interface generated on a display device by the image processing evaluator of FIG. 1;

FIG. 3 is a second user interface generated on a display device by the image processing evaluator of FIG. 1;

FIG. 4 is a state diagram that illustrating the operation of the image processing evaluator of FIG. 1; and

FIG. 5 is a flow chart that depicts an automated configuration portion of the image processing evaluator of FIG. 4.

### DETAILED DESCRIPTION OF THE INVENTION

In order to prevent a user from implementing the execution of an image processing operation that unreasonably taxes limited processing resources, an image processing evaluator is provided in a computer system. The image processing evaluator performs an evaluation of the processing resources when requested by a user who wishes to initiate an image processing operation to determine whether the image processing operation can be performed with adequate efficiency. The image processing evaluator provides information pertaining to the anticipated execution of the image processing operation in user displays. This information is provided before the actual execution of the image processing operation so that the user is given an opportunity to cancel the execution of or modify the execution of the image processing operation to prevent undesirable taxing of processing resources.

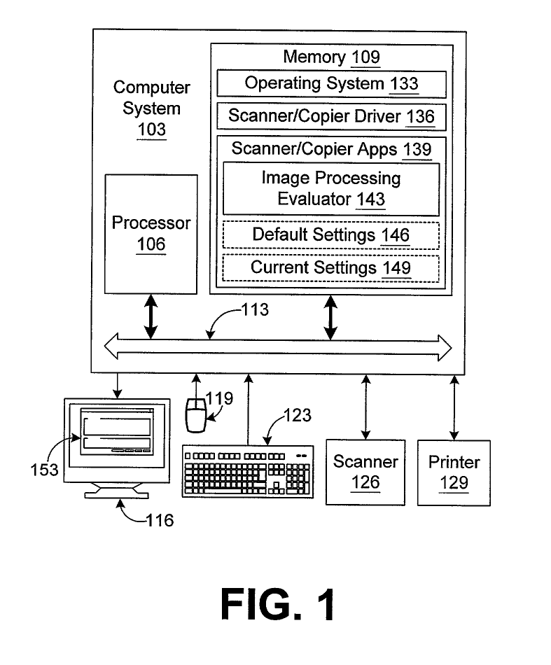

With this in mind, reference is made to FIG. 1 that shows an exemplary computer system 103 that performs various image processing operations. The computer system 103 includes a processor circuit having a processor 106 and a memory 109, both of which are coupled to a local interface 113. The local interface 113 may be, for example, a data bus with an accompanying control/address bus as can be appreciated by those with ordinary skill in the art. In this respect, the computer system 103 may be a general purpose computer or other device with like capability.

The computer system 103 includes a number of peripheral devices such as, for example, a display device 1 16, a mouse 119, a keyboard 123, a scanner 126, and a printer 129. Additional peripheral devices may include, for example, keypads, touch pads, touch screens, microphones, joysticks, or one or more push buttons, etc. The peripheral devices may also include indicator lights, speakers, etc. Also, many other peripheral devices may be employed with the computer system 103 as can be appreciated by those with ordinary skill in the art. The display device 116 may be, for example, a cathode ray tube (CRTs), liquid crystal display screen, gas plasma-based flat panel display, or other type of display device, etc. The various peripheral devices may be coupled to the local interface 113 using appropriate interface circuitry such as, for example, interface cards, buffers, and other circuits. Alternatively, the processor circuit in the computer system 103 may be located in a peripheral device or separate processor circuits may be located in both the computer system 103 and the peripheral device that perform the various functions described herein in distributed manner.

The computer system 103 also includes a number of components that are stored on the memory 109 and are executable by the processor 106. These components include an operating system 133, a scanner/copier driver 136, and any number of scanner/copier applications 139. Among the scanner/copier applications 139 is an image processing evaluator 143. Associated with the image processing evaluator 143 are default image processing settings 146 and current image processing settings 149. When executed, the image processing evaluator 143 generates one or more graphical user interfaces 153 on the display device 116. Alternatively, other user interfaces may be employed beyond the graphical user interfaces 153. The user may make appropriate inputs and otherwise manipulate information and/or devices on the user interfaces 153. This may be done, for example, by positioning a cursor with the mouse 119 and “clicking” on the various components or entering information using the keyboard 123 as can be appreciated by those with ordinary skill in the art.

While the image processing evaluator 103 is shown as implemented in the computer system 103, it is understood that the image processing evaluator 103 may be located on any device with suitable processing capabilities. For example, the image processing evaluator 103 may be embedded in the scanner 126 or located on a remote device coupled to the scanner 126 through a network, etc.

The memory 109 is defined herein as both volatile and nonvolatile memory and data storage components. Volatile components are those that do not retain data values upon loss of power. Nonvolatile components are those that retain data upon a loss of power. Thus, the memory 109 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 106 may represent multiple processors and the memory 109 may represent multiple memories that operate in parallel. In such a case, the local interface 113 may be an appropriate network that facilitates communication between any two of the multiple processors, between any processor and any one of the memories, or between any two of the memories etc. The processor 106 may be electrical, optical, or molecular in nature.

The operating system 133 is executed to control the allocation and usage of hardware resources in the computer system 103 such as the memory 109, processing time and peripheral devices. In this manner, the operating system 133 serves as the foundation on which applications depend as is generally known by those with ordinary skill in the art.

Next the operation of the computer system 103 is described. However, before a detailed description of the operation is provided, first a few definitional and foundational matters are discussed. The image processing evaluator 143 is executed during the performance of an image processing operation. An image processing operation is defined herein as scanning, copying, printing, or other task associated with image generation in the computer system 103 and printing thereof. In particular, the imaging processing operation may entail, for example, scanning an image from a print media such as a paper with the scanner 126 and storing the same in the memory 109 for future manipulation by various applications.

Associated with the execution of a respective image processing operation are a number of image processing settings that are stored, for example, on the memory 109. Initially the image processing settings are stored in the memory 109 as the default image processing settings 146. Upon execution of the image processing evaluator 143, the default image processing settings 146 are accessed and stored as the current settings 149 in the memory 109. The default image processing settings 146 may be stored, for example, in a data storage device in the memory 109 and the current image processing settings 149 may be stored, for example, in a random access memory component of the memory 109. The image processing settings 149 are employed during the performance of the actual image processing operation. Some example of image processing settings 146/149 may include, for example, a scan resolution in dots per inch, a color depth in bits per pixel, an output page size, a number of pages to be scanned, and other settings germane to an image processing operation.

The effectiveness of the execution of an image processing operation can be described or otherwise characterized by any number of image processing parameters. Some image processing parameters are dependent parameters that describe the usage of the processing resources including, for example, memory usage and the time duration of the processing function by the computer system 103 in executing an image processing operation while other image processing parameters may be chosen by the user. The memory usage may be described in terms of the various categories of memory that are employed such as, for example, random access memory, data storage space in the form of a hard drive or other similar storage device, or other parameter.

With the foregoing in mind, next a brief discussion of the general operation of the image processing evaluator 143 is provided in the context of an image processing operation such as, for example, a scan operation. To begin, assume, for example, that a user places a print medium with an image to be scanned in the scanner 126 to be stored in the memory 109. The user then initiates the scan operation, for example, by pressing an appropriate button on the scanner or by manipulating a user interface displayed on the display device 116 or other user interface. When the scan operation or any other image processing operation is initiated, then the image processing evaluator 143 is executed by the processor 106 to evaluate or forecast the effectiveness of the anticipated execution of the image processing operation in the computer system 103. In particular, the image processing evaluator 143 may forecast a number of image processing parameters that result based upon usage of the processing resources of the computer system 103.

The forecasting of the number of image processing parameters by the image processing evaluator 143 is performed in light of the current settings 149 that have been specified for the respective image processing operation. For example, in the context of the scanner 126, upon startup, various default settings 146 that are stored, for example, in a nonvolatile component in the memory 109 are accessed and copied and stored as the current image processing settings 149 to be employed during the image processing operation. The particular values that are assigned to the various image processing settings 149 define the nature of the execution of the image processing operation to be performed.

Depending on the image processing settings 149, the image processing parameters that are associated with the performance of the image processing operation may vary greatly. Ultimately, upon the initiation of the image processing operation, the image processing evaluator 143 first determines the image processing parameters based upon the current image processing settings 149. The image processing evaluator 143 then generates a user interface 153 or manipulates some other interface to inform the user of the current image processing settings 149 as well as the associated image processing parameters that result from the performance of the image processing operation.

Depending on the available hardware resources of the computer system 103, it may be the case that the computer system 103 cannot perform the image processing operation in an optimal manner. For example, assuming the image processing operation were a scan operation, assume that a high scan resolution and a dense color depth are both specified in the current image processing settings 149. Under these conditions, the computer system 103 might require a significant amount of time to process the image as it is scanned by the scanner 126 and stored in the memory 109. This time period may be much longer than the user is willing to wait. In order to address this unacceptable situation, the image processing evaluator 143 is executed just after a user initiates the desired image processing operation before the actual image processing operation begins. The image processing evaluator 143 then generates a user interface 153 on the display device 116 or uses some other interface to present the image processing parameters and/or the current image processing settings 149. The image processing settings 149 are presented in a manner that provides the user with the opportunity to modify them if the corresponding image processing parameters indicate an unacceptable performance of the image processing operation.

Once the image processing parameters and the associated current image processing settings 149 are displayed in the user interface 153, then the user may implement one of a number of preoperative tasks. Such tasks are labeled “preoperative” herein as they are performed before the actual execution of the image processing operation itself. The various preoperative tasks that a user may perform may include, for example, an actual initiation of the image processing operation itself or a cancellation of the image processing operation. Other preoperative tasks may include an alteration of the image processing settings 149 with a subsequent re-forecasting of the image processing parameters that are associated with the altered image processing settings 149. Alternatively, the user may implement the execution of an automated configuration of the image processing settings 149 based upon predetermined criteria as will be described.

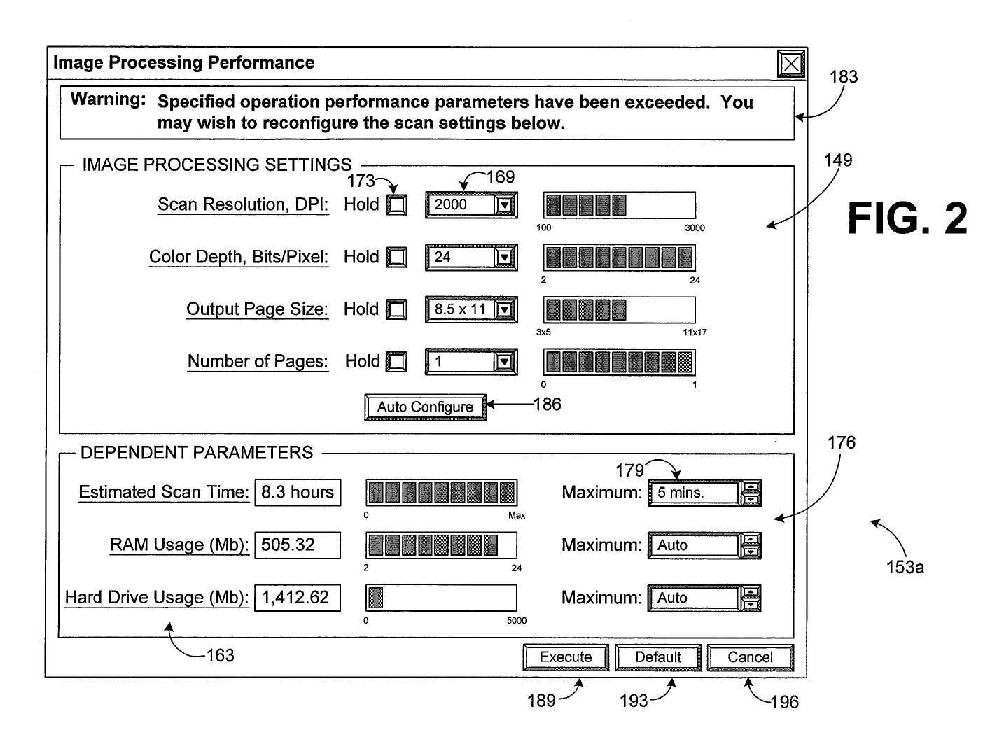

Turning to FIG. 2, shown is an example of a user interface 153a that is generated by the image processing evaluator 143 (FIG. 1) upon the initiation of an appropriate image processing operation. It is understood that the user interface 153a merely provides an example of how information may be presented to a user and that the actual appearance of the user interface and/or the nature of the components included therein may vary greatly from that shown in FIG. 2.

The user interface 153a presents the image processing parameters 163 that indicate the effectiveness of the anticipated execution of the image processing operation. In this respect, the image processing parameters 163 are generated by the image processing evaluator 143 based upon the image processing settings 149. By way of example, FIG. 2 shows image processing settings 149 related to a scan operation including, for example, a scan resolution, color depth, output page size, and number of pages. Each of the image processing settings 149 is indicated with an appropriate value 169 as well as a graphical depiction of the value 169 in a bar graph that depicts the value relative to the highest and lowest potential values associated therewith. It is possible that one of any number of different types of graphical components beyond those depicted in FIG. 2 may be employed to depict a value for each one of the image processing settings 149 as can be appreciated by those with ordinary skill in the art. Also associated with each image processing setting 149 is a hold indicator 173, the significance of which will be described in later text.

The user interface 153 depicts the image processing parameters 163 both in numerical and graphical format. It is understood that the image processing parameters 163 may be depicted in any one of a number of different graphical indicators as can be appreciated by anyone with skill in the art. The image processing parameters 163 include, for example, an estimated time period for the duration of the image processing operation, as well as memory usage parameters. The user interface 153a also presents performance measurement criteria 176 that is associated with the image processing parameters 163. The performance measurement criteria 176 includes, for example, an execution time threshold 179 as well as other thresholds relating to the use of various memory components when such thresholds are desirable. The user may specify values to be used as the various thresholds. In some cases, the selection may be left to the image processing evaluator 143 by selecting an “auto” designation for “automatic” as shown. The thresholds may be, for example, minimum or maximum values. The performance measurement criteria 176 provide performance benchmarks with which the respective image processing parameters 163 may be compared to ascertain whether the anticipated execution of the image processing operation falls within acceptable limits.

The user interface 153a also includes an operation evaluation message 183 that provides a user with specific information relating to the desired image processing operation. For example, the operation evaluation message 183 may indicate that the anticipated execution of the image processing operation can be performed within the limits specified by the performance measurement criteria 176. The operation evaluation message 183 may also indicate that the limits that were specified by the performance measurement criteria 176 are exceeded at the current image processing image settings 149. As an additional alternative, the operation evaluation message 183 may indicate that the computer system 103 simply lacks the available processing resources to perform the desired image processing. Also, the operation evaluation message 183 may indicate other conditions as is appropriate.

The user interface 153a also includes an “Auto Configure” button 186 that may be manipulated by a user to implement an automated optimization of the image processing settings 149. The automated optimizations determines image processing settings 149 to employ in the execution of the image processing operation in a manner such that no image processing parameter 163 breaches a threshold specified in the performance measurement criteria 176.

Alternatively, the user may manually make changes to the various image processing settings 149 by manipulating the appropriate components in the user interface 153a. Upon detecting that a manual change has occurred, the image processing evaluator 143 reevaluates the effectiveness of the anticipated execution of the imaging processing operation in light of the altered image processing setting 149. The reevaluation may occur after the lapse of a predetermined period of inactivity after a manual change.

The user interface 153a also includes an “Execute” button 189, a “Default” button 193, and a “Cancel” button 196. If the user perceives the image processing parameters 163 to be acceptable, the user may manipulate the Execute button 189 to initiate the image processing operation. Alternatively, the user may manipulate the Cancel button 196 to cancel the implementation of the image processing operation. This may be the case, for example, when the user discerns that the execution of the image processing operation will take too long. In some situations, the Execute button 189 may be “grayed out” or otherwise rendered inoperative in circumstances where the image processing operation cannot be performed by the computer system 103. The user may manipulate the Default button 193 in order to view and alter the default settings 146 (FIG. 1). The manipulation of the Default button 193 causes the image processing evaluator 143 to generate a second user interface that provides the user with the opportunity to alter the default settings 146.

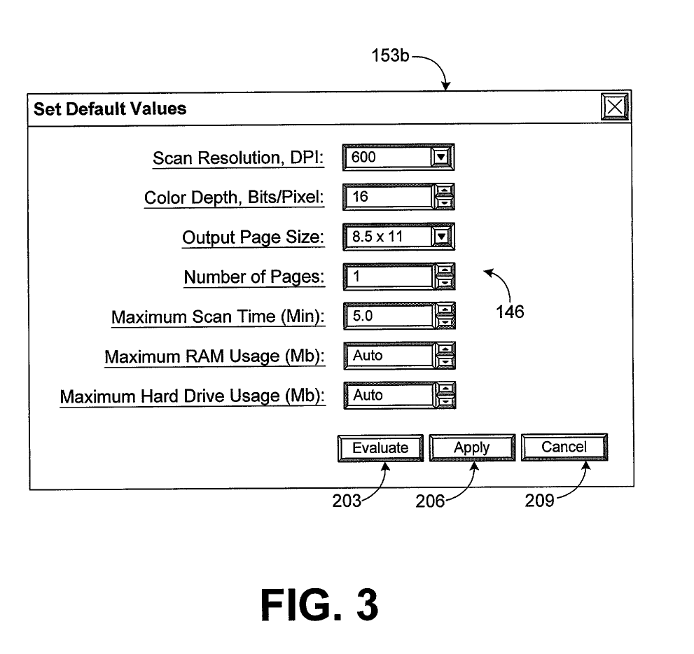

With reference to FIG. 3, shown is an example of a user interface 153b that presents each of the default image processing settings 146. The user interface 153b is exemplary in that it is understood that the appearance user interface 153b may vary greatly in its depiction of the default image processing settings 146 as can be appreciated by those with ordinary skill in the art. The user interface 153b is generated on the display device 116 (FIG. 1) upon a manipulation of the Default button 193 (FIG. 2) by the user. The default image processing settings 146 presented in the user interface 153b may be altered by the user. The user interface 153b includes an “Evaluate” button 203, an “Apply” button 206, and a “Cancel” button 209. After changing desired default image processing settings 146, the user may then manipulate the Evaluate button 203 causing the image processing evaluator 143 to replace the current image processing settings 149 with the default image processing settings 146. Thereafter, an evaluation of the effectiveness of the anticipated execution of the image processing operation is performed in light of the new image processing settings 149 (FIG. 1). The image processing evaluator 143 then displays the user interface 153a (FIG. 2) on the display device 116.

The user may also manipulate the Apply button 206 in the user interface 153b to cause the image processing evaluator 143 to replace the default image processing settings 149 with those settings displayed in the user interface 153b. Finally, the user may manipulate the Cancel button 209 to cause the image processor evaluator 143 to revert back to the user interface 153a taking no action to alter the default image processing settings 146 in the memory 109.

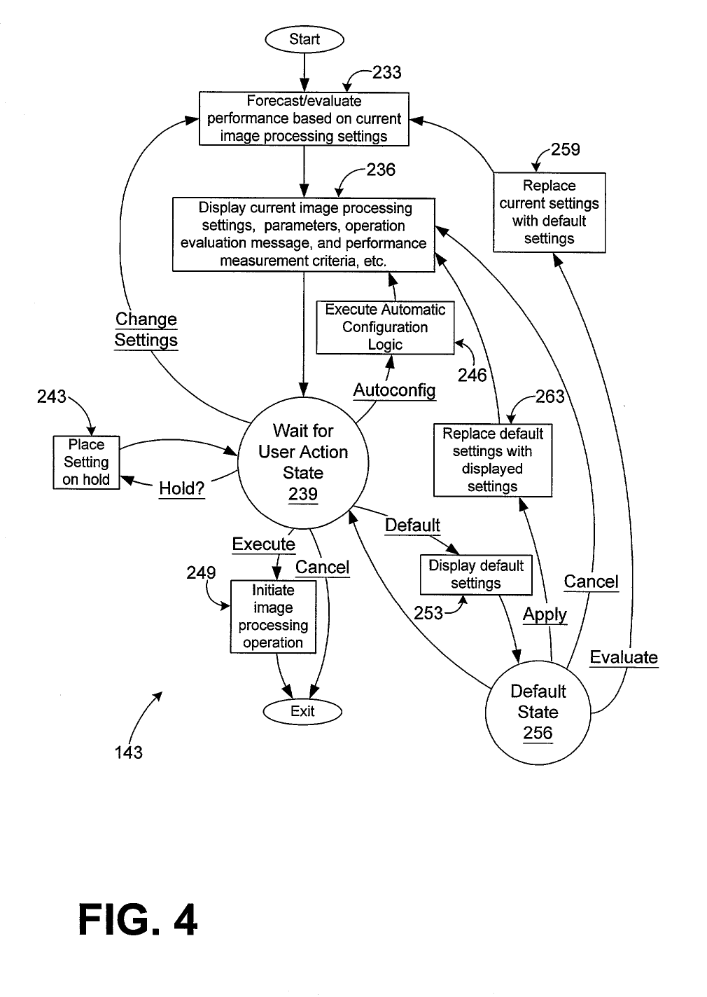

With reference to FIG. 4, shown is a state diagram depicting the operation of the image processing evaluator 143 according to an aspect of the invention. Alternatively, the state diagram of FIG. 4 may viewed as depicting various steps in a method implemented in a computer system 103 (FIG. 1) to provide a user with the ability to view and/or alter image processing settings 149 (FIG. 2) in order to perform an image processing operation.

Beginning with box 233, the image processing evaluator 143 evaluates the effectiveness of the anticipated execution of the desired image processing operation in the computer system 103 based upon the current image processing settings 149. In performing this task, the image processing evaluator 143 may forecast a number of image processing parameters 163 (FIG. 2) associated with the desired image processing operation that is based upon the current image processing settings 149. Some or all of the image processing parameters 163 may be compared with predefined threshold values specified in the performance measurement criteria or with physical limitations of the respective computer system 103 to obtain a proper measure of the anticipated performance of the image processing operation.

When the evaluation is complete in box 233, the image processing evaluator 143 proceeds to box 236 in which the user interface 153a (FIG. 2) is generated on the display device 116 (FIG. 1). As was described above, the user interface 153a presents the image processing settings 149, the image processing parameters 163 (FIG. 2), an operation evaluation message 183 (FIG. 2), and the performance measurement criteria 176 (FIG. 2). Alternatively, the content displayed in the user interface 153a may vary as is deemed appropriate. Also, the same information may be presented to a user via some other medium beyond the user interface 153a such as, for example, via printing or other indicator.

After presenting the user interface 153b, the image processing evaluator 143 enters a “Wait for User Action” state 239 in which the image processing evaluator 143 waits for further action on the part of the user. Assuming if the user changes any one of the image processing settings 149, then the image processing evaluator 143 reverts back to box 233 as shown. The detection of whether the user has changed settings may be accomplished by the detection of an inactivity timeout that occurs after a user has changed a particular image processing setting 149. Alternatively, some other component such as, for example, a button may be included in the user interface 153a that triggers the evaluation of the image processing operation in light of altered image processing settings 149.

From the “Wait for User Action” State 239, the user may place one or more image processing settings 149 on hold by manipulating the associated hold indicator 173 (FIG. 2). Upon such action, the image processing evaluator 143 proceeds to box 243 in which the respective image processing settings 149 is placed on hold accordingly. The image processing evaluator 143 may place an image processing setting 149 on hold, for example, by writing an appropriate data value representing the hold status of the respective image processing setting 149 to a predefined register in the memory 109. Thereafter, the image processing evaluator 143 reverts back to the “Wait for User Action” State 239.

In some situations, a user may wish to automatically alter the image processing settings 149 in an attempt to find an acceptable configuration for the image processing settings 149 that results in an acceptable performance of the image processing operation. If such is the case, the user may manipulate the “Auto Configure” button 186 (FIG. 2) to cause the image processing evaluator 143 to proceed to box 246. In box 246 image processing evaluator executes automatic configuration logic to adjust the image processing settings 149 to an acceptable configuration as will be described. Once the automatic configuration of the image processing settings 149 is complete, then the image processing evaluator 143 reverts to box 236 to display the new image processing settings 149, etc.

Assuming that the image processing parameters 163 are acceptable to the user to perform the desired image processing operation, then the user may manipulate the Execute button 189 (FIG. 2). In such case, the image processing evaluator 143 proceeds to box 249 in which the desired image processing operation is initiated by the image processing evaluator 143. Thereafter, the operation of the image processing evaluator 143 ends. As another alternative, the user may manipulate the Cancel button 196 (FIG. 2) to cause the image processing evaluator 143 to leave the “Wait for User Action” State 239 and end as shown.

In addition, when in the “Wait for User Action” State 239, if the user manipulates the Default button 193, then the image processing evaluator 143 proceeds to box 253 to display the user interface 153b (FIG. 3) that includes the default image processing settings 146 (FIG. 1). Thereafter, the image processing evaluator 143 enters a default state 256. When in the default state 256, if the user manipulates the Evaluate button 203, then the image processing evaluator 143 proceeds to box 259 in which the current image processing settings 149 (FIG. 2) are replaced with the default image processing settings 146 (FIG. 3). Thereafter, the image processing evaluator 143 reverts back to box 233 to forecast or evaluate the image processing operation in light of the new current image processing settings 149.

If the user manipulates the Apply button 206 (FIG. 3) in the user interface 153b, then the image processing evaluator 143 proceeds to box 263 in which the default image processing settings 146 are replaced with the image processing settings that are displayed in the user interface 153b. In this manner, a user may then change the default image processing settings 146 that are employed with the image processing evaluator 143. Thereafter, the image processing evaluator 143 reverts back to box 236 to display the user interface 153a.

If while in the default state 256, the user manipulates the Cancel button 209 (FIG. 3), then the image processing evaluator 143 reverts to box 236 to display the user interface 153a without taking further action relative to the default image processing settings 146 (FIG. 2).

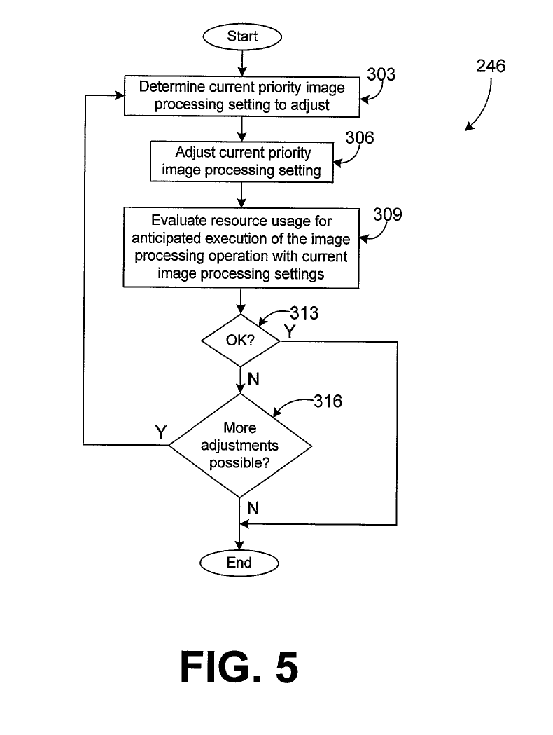

With reference to FIG. 5, shown is a flow chart of the automatic configuration logic 246 that is executed in the image processing evaluator 143 in order to automatically determine an optimum configuration for the current image processing settings 149 (FIG. 1) to perform the image processing operation. Alternatively, the flow chart of FIG. 5 may be viewed as depicting steps in a method implemented in the computer system 103 to automatically determine the optimum configuration of the current image processing settings 149 to perform the image processing operation in the computer system 103.

Beginning with box 303, the automatic configuration logic 246 identifies a current priority image processing setting 149 that is to be adjusted in order to obtain a more efficient execution of the image processing operation. For example, for a scan operation, the scan resolution or color depth may be selected for reduction by an incremental amount. The selection of the specific image processing setting 149 that is to be adjusted may be made according to a predetermined selection table or formula maintained in the memory 109 (FIG. 1) or by another approach. However, any image processing setting 149 that has been placed on hold by manipulation of a corresponding hold indicator 173 (FIG. 2) is excluded from selection for adjustment by the automatic configuration logic 246. This provides the user with an ability to control the image processing settings 149 (FIG. 2) that are subject to automatic optimization as desired.

Thereafter, in box 306, the current priority image processing setting 149 is adjusted by changing it by an incremental amount as is appropriate for the respective image processing setting 149. The precise incremental amount may be predetermined based upon the nature of the image processing setting 149 in question. For example, with regard to scan resolution in a scan operation, there may only be certain incremental values of scan resolution that can be specified depending upon the variations allowed by the scanner 126 (FIG. 1). Then, the automatic configuration logic 246 proceeds to box 309 in which the processing resource usage for the anticipated execution of the image processing operation is evaluated estimated in light of the current image processing settings 149.

Next, if box 313 the anticipated execution of the image processing operation can be performed within the performance measurement criteria 176 (FIG. 2) specified by the user, then the automatic configuration logic 246 ends. On the other hand, if the anticipated execution of the image processing operation cannot occur within the bounds of the performance measurement criteria 176, then the automatic configuration logic 246 proceeds to box 316. In box 316 it is determined whether there remains any image processing setting(s) 149 that can adjusted to reduce the processing load presented by the anticipated execution of the image processing operation. If such is the case, then the automatic configuration logic 246 reverts back to box 303 to identify the next priority image processing setting 149 for adjustment. It is possible that the same image processing setting 149 that was previously adjusted may be adjusted again if it remains as the current priority image processing setting in box 303. However, if there exists no further image processing setting 149 that can be further adjusted in box 316, then the automatic configuration logic 246 ends. In some circumstances, image processing operation cannot be successfully performed after an automated attempt to obtain an optimum configuration of the image processing settings 149. In such case the user is informed of such circumstance as described in box 236 (FIG. 4) and may be prevented from executing the image processing operation. Alternatively, the user may be informed that the image processing operation may be successfully executed.

Although the image processing evaluator 143 is embodied in software or code executed by general purpose hardware as discussed above, as an alternative the image processing evaluator 143 may also be embodied in dedicated hardware or a combination of software/general purpose hardware and dedicated hardware. If embodied in dedicated hardware, the image processing evaluator 143 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The state diagram of FIG. 4 and flow chart of FIG. 5 show the architecture, functionality, and operation of an implementation of the image processing evaluator 143. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the state diagram of FIG. 4 and flow chart of FIG. 5 show a specific order of execution or architecture, it is understood that the order of execution or architecture may differ from that which is depicted. For example, the order of execution of two or more blocks may be scrambled relative to the order shown. Also, two or more blocks shown in succession in FIGS. 4 and 5 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention.

Also, where the image processing evaluator 143 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the image processing evaluator 143 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain embodiments, it is obvious that equivalents and modifications will occur to others skilled in the art upon the reading and understanding of the specification. The i present invention includes all such equivalents and modifications, and is limited only by the scope of the claims.

What is claimed is:

1. An image processing evaluation method, comprising:
forecasting a number of image processing parameters of an image processing operation based upon at least one image processing setting;
displaying the image processing parameters on a display device;
altering the at least one image processing setting based upon a user setting input;
re-forecasting the number of image processing parameters based upon the at least one image processing setting altered by the user setting input; and
performing a preoperative task based upon a user input in response to the display of the image processing parameters.

2. The image processing evaluation method of claim 1, further comprising associating at least one threshold with at least one of the image processing parameters, thereby providing a performance benchmark with which a value for the at least one of the image processing parameters may be compared.

3. The image processing evaluation method of claim 2, wherein the associating of the at least one threshold with the at least one of the image processing parameters further comprises automatically determining the at least one threshold.

4. The image processing evaluation method of claim 1, wherein the performing of the preoperative task based upon the user input further comprises initiating the image processing operation.

5. The image processing evaluation method of claim 1, wherein the performing of the preoperative task based upon the user input further comprises canceling the image processing operation.

6. The image processing evaluation method of claim 1, wherein the performing of the preoperative task based upon the user input further comprises automatically determining an optimum configuration for the at least one image processing setting to perform the image processing operation.

7. The image processing evaluation method of claim 6, wherein the automatically determining of the optimum configuration for the at least one image processing setting to perform the image processing operation further comprises determining whether at least one of the image processing parameters exceeds at least one threshold associated therewith.

8. The image processing evaluation method of claim 1, wherein the forecasting of the number of image processing parameters of the image processing operation based upon the at least one image processing setting further comprises forecasting the image processing parameter based upon the at least one image processing setting that includes a number of scan settings.

9. The image processing evaluation method of claim 1, wherein the forecasting of a number of image processing parameters of an image processing operation based upon at least one image processing setting further comprises determining an execution time of the image processing operation based on the at least one image processing setting, wherein the image processing operation is a scan operation and the at least one image processing setting includes at least one scan setting.

10. The image processing evaluation method of claim 9, wherein the forecasting of the number of image processing parameters of the image processing operation based upon the at least one image processing setting further comprises comparing the execution time with at least one execution time threshold to obtain a measure of the performance of the image processing operation.

11. The image processing evaluation method of claim 1, further comprising displaying an operation evaluation message on the display device indicating an expected measure of performance of the image processing operation.

12. An image processing evaluation program embodied in a computer readable medium, comprising:
code that evaluates an effectiveness of an anticipated execution of the image processing operation in a computer system;
code that presents a number of image processing parameters to a user, the image processing parameters indicating the effectiveness of the anticipated execution of the image processing operation; and
code that provides for an alteration of a number of image processing settings that correspondingly alters the effectiveness of the anticipated execution of the image processing operation.

13. The image processing evaluation program embodied in the computer readable medium of claim 12, further comprising code that provides for an execution of the image processing operation based upon a user input.

14. The image processing evaluation program embodied in the computer readable medium of claim 12, further comprising code that prevents the execution of the image processing operation when the computer system is incapable of performing the image processing operation.

15. The image processing evaluation program embodied in the computer readable medium of claim 12, further comprising code that provides for at least one threshold associated with at least one of the image processing parameters, thereby providing a performance benchmark with which a value for the at least one of the image processing parameters may be compared.

16. The image processing evaluation program embodied in the computer readable medium of claim 15, wherein the code that provides for at least one threshold associated with the at least one of the image processing parameters further comprises code that automatically determines the at least one threshold.

17. The image processing evaluation program embodied in the computer readable medium of claim 12, further comprising code that automatically optimizes the image processing settings.

18. The image processing evaluation program embodied in the computer readable medium of claim 17, further comprising code that withholds at least one of the image processing settings from an automated optimization operation.

19. The image processing evaluation program embodied in the computer readable medium of claim 12, wherein the code that evaluates the effectiveness of the anticipated execution of the image processing operation in the computer system further comprises code that estimates an amount of time for a full execution of the image processing operation.

20. The image processing evaluation program embodied in the computer readable medium of claim 12, wherein the code that evaluates the effectiveness of the anticipated execution of the image processing operation in the computer system further comprises code that estimates a minimum amount of at least one type of memory that is necessary to perform the image processing operation.

21. The image processing evaluation program embodied in the computer readable medium of claim 12, wherein the image processing operation is a scan operation.

22. The image processing evaluation program embodied in the computer readable medium of claim 21, wherein at least one of the image processing settings is selected from the group consisting of a scan resolution of the scan operation, a color depth of the scan operation, and a page size of the scan operation.

23. An image processing evaluation system, comprising:
a processor circuit having a processor and a memory;
an image processing evaluator stored in the memory and executable by the processor, the image processing evaluator comprising:
logic that evaluates an effectiveness of an anticipated execution of the image processing operation in a computer system;
logic that presents a number of image processing parameters to a user, the image processing parameters indicating the effectiveness of the anticipated execution of the image processing operation; and
logic that provides for an alteration of a number of image processing settings that correspondingly alters the effectiveness of the anticipated execution of the image processing operation.

24. The image processing evaluation system of claim 23, wherein the image processing evaluator further comprises logic that provides for an execution of the image processing operation based upon a user input.

25. The image processing evaluation system of claim 23, wherein the image processing evaluator further comprises logic that provides for at least one threshold associated with at least one of the image processing parameters, thereby providing a performance benchmark with which a value for the at least one of the image processing parameters may be compared.

26. The image processing evaluation system of claim 25, wherein the logic that provides for the at least one threshold associated with the at least one of the image processing parameters further comprises logic that automatically determines the at least one threshold.

27. The image processing evaluation system of claim 23, wherein the image processing evaluator further comprises logic that prevents the execution of the image processing operation when the computer system is incapable of performing the image processing operation.

28. The image processing evaluation system of claim 23, wherein the image processing evaluator further comprises logic that automatically optimizes the image processing settings.

29. The image processing evaluation system of claim 28, wherein the image processing evaluator further comprises logic that withholds at least one of the image processing settings from an automated optimization operation.

30. The image processing evaluation system of claim 23, wherein the logic that evaluates the effectiveness of the anticipated execution of the image processing operation in the computer system further comprises logic that estimates an amount of time for a full execution of the image processing operation.

31. The image processing evaluation system of claim 23, wherein the logic that evaluates the effectiveness of the anticipated execution of the image processing operation in the computer system further comprises logic that estimates a minimum amount of at least one type of memory that is necessary to perform the image processing operation.

32. The image processing evaluation system of claim 23, wherein the image processing operation is a scan operation.

33. The image processing evaluation system of claim 32, wherein at least one of the image processing settings is selected from the group consisting of a scan resolution of the scan operation, a color depth of the scan operation, and a page size of the scan operation.

34. A system for image processing operation evaluation, comprising:
means for evaluating an effectiveness of an anticipated execution of an image processing operation in a computer system;
means for presenting a number of image processing parameters to a user, the image processing parameters indicating the effectiveness of the anticipated execution of the image processing operation; and
means for altering of a number of image processing settings that correspondingly alters the effectiveness of the anticipated execution of the image processing operation.

35. An image processing evaluation program embodied in a computer readable medium, comprising:
code that evaluates an effectiveness of an anticipated execution of the image processing operation in a computer system by estimating an amount of time for a full execution of the image processing operation and by estimating a minimum amount of at least one type of memory that is necessary to perform the image processing operation;
code that presents a number of image processing parameters to a user, the image processing parameters indicating the effectiveness of the anticipated execution of the image processing operation;
code that prevents the execution of the image processing operation when the computer system is incapable of performing the image processing operation; and
code that provides for an execution of the image processing operation based upon a user input.

36. The image processing evaluation program embodied in the computer readable medium of claim 35, further comprising code that facilitates a manual alteration of a number of image processing settings that correspondingly alters the effectiveness of the anticipated execution of the image processing operation.

37. The image processing evaluation program embodied in the computer readable medium of claim 36, further comprising code that automatically optimizes the image processing settings.

38. The image processing evaluation program embodied in the computer readable medium of claim 37, wherein the image processing operation is a scan operation.

39. The image processing evaluation program embodied in the computer readable medium of claim 37, wherein at least one of the image processing settings is selected from the group consisting of a scan resolution of the scan operation, a color depth of the scan operation, and a page size of the scan operation.

40. An image processing evaluation method, comprising:
forecasting a number of image processing parameters of an image processing operation based upon at least one image processing setting, the image processing parameters including an estimate of an execution time of the image processing operation and an estimate of a minimum amount of at least one type of memory necessary to perform the image processing operation;
displaying the image processing parameters on a display device; and
performing a preoperative task based upon a user input in response to the display of the image processing parameters.

41. The image processing evaluation method of claim 40, wherein the step of performing the preoperative task based upon the user input in response to the display of the image processing parameters further comprises initiating the image processing operation.

42. The image processing evaluation method of claim 40, wherein the step of performing the preoperative task based upon the user input in response to the display of the image processing parameters further comprises canceling the image processing operation.

43. The image processing evaluation method of claim 40, wherein the step of performing the preoperative task based upon the user input in response to the display of the image processing parameters further comprises:
altering the at least one image processing setting based upon a user setting input; and
re-forecasting the number of image processing parameters based upon the at least one image processing setting altered by the user setting input.

44. The image processing evaluation method of claim 40, wherein the step of performing the preoperative task based upon the user input in response to the display of the image processing parameters further comprises automatically determining an optimum configuration for the at least one image processing setting to perform the image processing operation.
